(19) United States
(12) Patent Application Publication
(10) Pub. No.: US 2026/0209562 A1
(43) Pub. Date: Jul. 23, 2026

(54) LABELING MATERIAL

(71) Applicant: Phoenix Contact GmbH & Co. KG, Blomberg (DE)

(72) Inventors: Michael PETER, Lage (DE); Manuela PAUS, Münster (DE); Kilian KLAGES, Detmold (DE); Albrecht SCHIERHOLZ, Schieder- Schwalenberg (DE); Christian DALMER, Paderborn (DE)

(21) Appl. No.: 19/140,362

(22) PCT Filed: Dec. 5, 2023
(86) PCT No.: PCT/EP2023/084269

§ 371 Date: Jun. 18, 2025

(30) Foreign Application Priority Data
Dec. 22, 2022 (BE) BE2022/6068

(51) Int. Cl. C09J 7/29; B32B 3/26; B32B 7/12; B32B 27/08; B32B 27/36

(52) U.S. Cl. CPC C09J 7/29; B32B 3/266; B32B 7/12; B32B 27/08; B32B 27/36; B32B 2250/02; B32B 2250/03; B32B 2250/244; B32B 2307/402; B32B 2307/412; B32B 2307/7376; B32B 2519/00; C09J 2203/334; C09J 2301/162; C09J 2301/18; C09J 2467/006

(57) ABSTRACT

A labeling material for identifying elements includes: a cover layer formed from a first polymer material and having a surface to be marked with a printing device; and a base layer formed from a second polymer material. The cover layer is arranged via a side facing away from a surface on the base layer. The first polymer material is formed from a polymer material of a higher quality than the second polymer material.

### CROSS-REFERENCE TO PRIOR APPLICATIONS

This application is a U.S. National Phase application under 35 U.S.C. § 371 of International Application No. PCT/EP 2023/084269, filed on Dec. 5, 2023, and claims benefit to Belgian Patent Application No. BE 2022/6068, filed on Dec. 22, 2022. The International Application was published in German on Jun. 27, 2024 as WO 2024/132492 A1 under PCT Article 21(2).

### FIELD

The invention relates to a labeling material used to identify elements.

### BACKGROUND

Such a labeling material comprises a cover layer formed from a first polymer material, having a surface for marking with a printing device, and a base layer formed from a second polymer material, wherein the cover layer is arranged via its side facing away from the surface on the base layer.

In the prior art, such a labeling material is often used for the industrial identification of elements in control cabinet installation and plant construction, such as for the identification of electrical components, terminal blocks, conductors, cables, pipes, etc. For this purpose, the labeling material is usually printed with an identification using a printing device. The identification often contains information regarding the route of a conductor, for example which terminal an electrical conductor should be connected to. Additionally or alternatively, the identification may also include an identification number in order to be able to clearly identify the element thus marked.

Usually, the labeling material is provided with the different identifications in one pass, for example by printing, and then separated into differently marked labeling elements to identify different elements. Alternatively, the labeling material can also be separated before being provided with markings.

The printing process requires high surface quality, such as low roughness and only a few (preferably no) surface defects, in order to achieve a good, continuous print image with high contrast. To use the labeling material for industrial identification, a certain thickness of the material of the identification carrier is required in order to achieve sufficient mechanical rigidity and strength. Therefore, in the prior art, the printing material was often made of a single layer of a sufficiently thick film of a high-quality, and therefore easily printable but also very expensive, polymer material. Multi-layer labeling materials are also known-such as those described in DE 10 2019 105 526 A1.

### SUMMARY

In an embodiment, the present invention provides a labeling material for identifying elements, the labeling material comprising: a cover layer comprising a first polymer material and having a surface configured to be marked with a printing device; and a base layer comprising a second polymer material, wherein the cover layer is arranged via a side facing away from a surface on the base layer, and wherein the first polymer material comprises a polymer material of a higher quality than the second polymer material.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIGS. 1-3 show sectional views through a labeling material according to various embodiments; and

FIG. 4 is a plan view of a labeling material according to one embodiment.

### DETAILED DESCRIPTION

In an embodiment, the present invention provides a cost-effective labeling material that can be marked with high quality, and is easy to laser cut and/or punch. Furthermore, it is an object of the present invention to provide a sustainably usable labeling material that is recyclable.

Accordingly, the first polymer material comprises a polymer material with a higher quality than the second polymer material.

The term “quality” may be used herein to refer to at least one inherent characteristic of the polymer material or to describe the totality of all inherent characteristics of the polymer material. In particular, the term “quality” is intended to describe the grade of the inherent characteristic(s). A “higher quality” polymer material may be understood herein to mean a polymer material that has a different melting temperature, crystallization, viscosity, molecular weight distribution and/or toughness than a “lower quality” polymer material.

For example, the first polymer material may have very good surface properties and therefore be very suitable for marking by a printing device, such as a thermal transfer printer, laser printer and/or inkjet printer. Furthermore, the first polymer material can be made into a thin layer.

For example, the second polymer material with a lower quality may be cheaper to produce, but provide good mechanical stiffness and tensile strength for marking and for arranging the labeling element on the element being identified. The mechanical properties of the labeling material can be advantageously determined by the thickness or the ratio of the thicknesses of the layers.

A further advantage is that a material constructed in this way is also easily deformable and is therefore also suitable for application to cylindrical elements, i.e., to identify these elements.

In one example, the first polymer material comprises a G-PET polyethylene terephthalate material and the second material comprises an A-PET polyethylene terephthalate material.

G-PET material can be understood as a glycol-modified PET material that has very good surface properties, and is therefore of higher quality than A-PET material.

The A-PET polyethylene terephthalate material can contain up to 100% recycled material and can be amorphous as well as transparent. The A-PET material has a lower quality than the G-PET material, but is inexpensive to produce and has good stiffness and strength.

In one example, the cover layer has a thickness DI and the base layer has a thickness D2, wherein the thickness D1 of the cover layer is less than the thickness D2 of the base layer.

The cover layer and the base layer can be designed to be complementary to each other, congruently overlapping, and unprofiled and/or uniform, but the layer thicknesses D1 and D2 can be different in order to advantageously minimize the thickness D1 of the expensive cover layer comprising the material with a higher quality.

In one example, the thickness DI of the cover layer is in a range of two to ten times, in particular five times, less than the thickness D2 of the base layer.

It has been shown that a thickness ratio in the previously described range is easy to print, has good mechanical properties and is inexpensive to produce.

In one example, the thickness D1 of the cover layer is less than or equal to 50 μm, in particular less than or equal to 10 μm.

For example, polymer films in which the cover layer has a thickness D1 of less than or equal to 50 μm, in particular less than or equal to 10 μm, can advantageously be produced by co-extrusion and calendering.

In one example, the cover layer or the base layer is colored and the other layer is transparent, in particular the cover layer is colored and the base layer is transparent.

For example, by adding a pigment or a color pattern to one of the layers while the other layer is transparent, a marking can be created independently of the subsequent printing by means of the printing device. For example, all similar elements to be identified, such as a specific terminal type, can be marked with labeling elements made from the labeling material that have the same color. Furthermore, by coloring an area of one of the layers, a position marking can be created, for example to show the user how the labeling material is to be inserted into the printing device. The position marking can then be detected, for example, by an optical detector, such as a light sensor, a light barrier or the like.

In one example, an adhesive layer is arranged at least partially between the cover layer and the base layer for connecting the cover layer to the base layer.

The term “adhesive layer” can be understood here as an adhesive film which can be applied in liquid form, at least in part, to one of the layers before the other layer is applied to the adhesive film. Furthermore, the two layers can be pressed and/or heated to create a material bond. Other processes, such as heat sealing, can also be used to bond the cover layer and the base layer. For example, it may be that only some areas of the two layers are glued together.

In one example, the surface of the cover layer is configured to be marked by means of a thermal transfer, laser and/or inkjet printing device.

The advantage of a G-PET material is that it is easy to mark and does not, like a PVC material, produce acid when exposed to heat, such as can be caused by laser beam input. This allows good printing results to be achieved with no or only minor display errors, while at the same time avoiding damage to equipment or the health of the system operator. Another advantage is that the planar design of the cover layer surface ensures that the distance to the labeling head of the printing device used remains the same, which enables a consistent and distortion-free print image.

In one example, the labeling material comprises an adhesive, wherein the adhesive is arranged at least in places on a region of the base layer in order to arrange the labeling material on the element being identified, in particular to arrange it in a materially bonded manner.

For example, the adhesive can be realized using double-sided adhesive tape. Advantageously, the labeling material or the labeling elements obtained from the labeling material can simply be glued onto the element being identified. Alternatively or in addition to arranging by means of adhesive, the labeling material or the labeling elements obtained from the labeling material can also be arranged in a form-fitting and/or force-fitting manner on the element being identified.

In one example, the labeling material is flat or strip-shaped.

The labeling material can advantageously be provided in the form of a continuous roll in both printed and unprinted form to save space.

In one example, at least one material weakening, in particular a perforation, is introduced into the cover layer and/or the base layer in order to separate the labeling material into at least two labeling elements.

The material weakening can be introduced as a punched perforation into the material of the layers; for example, the perforation can be designed as a round hole perforation, slotted hole perforation, etc. Alternatively, the material weakening can also be designed as a material taper. Furthermore, the material weakening can also be introduced into the material of the layers using a laser, or the labeling material can be separated into labeling elements using a laser. The labeling elements can also be punched out of the labeling material in one piece.

Advantageously, the labeling elements can be removed from the labeling material with an individual geometry according to the intended use, since a two-layer design of the labeling material with a cover layer and a base layer can be cut and punched particularly well compared to a multi-layer design. Furthermore, the PET material can be easily separated with a laser due to its good temperature resistance, which means that even small quantities can be produced economically.

In one example, at least one further material weakening is introduced into the cover layer and/or base layer of at least one of the separated labeling elements in order to attach the labeling element to the element being identified.

Advantageously, a fastening means, such as a cable tie, can be guided through the further material weakening in the form of a recess or opening, for easy fastening of the labeling element to the element being identified.

In one example, the labeling material comprises at least one further cover layer, wherein the further cover layer is preferably arranged opposite the cover layer on the base layer. Alternatively, the further cover layer can also be arranged on a side surface of the base layer at a right angle to the cover layer. In one example, the further cover layer comprises a further first polymer material having a higher quality than the second polymer material of the base layer. The further first polymer material may be the same as the first polymer material, but may also be a polymer material with a higher quality than the second polymer material, which is different from the first polymer material. For example, the further first polymer material may be another G-PET polyethylene terephthalate material.

Advantageously, a labeling material designed in this way can be printed on both sides, wherein a multi-layer polymer film designed in this way is more cost-effective than, for example, a single-layer G-PET polymer film.

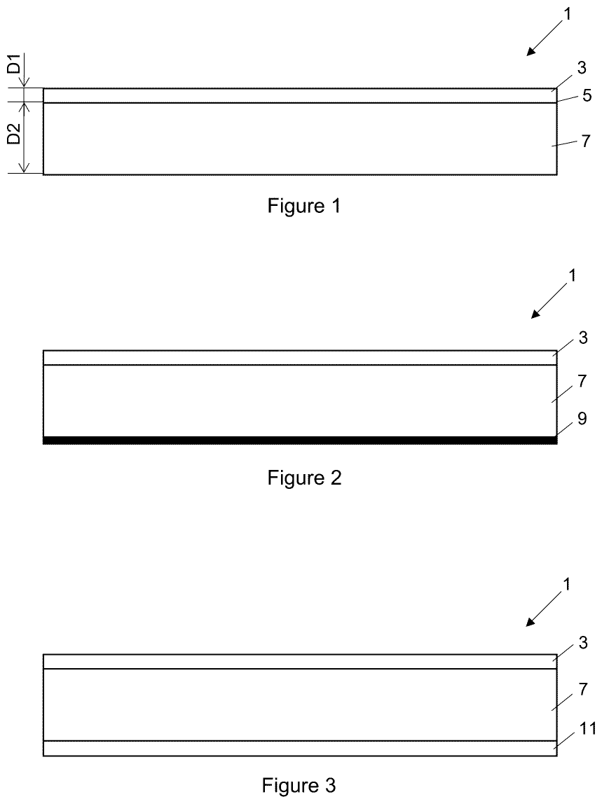

FIG. 1 shows a sectional view of a labeling material 1 according to one embodiment.

The labeling material 1 shown comprises a cover layer 3 formed from a first polymer material, having a surface for marking with a printing device, and a base layer 7 formed from a second polymer material, wherein the cover layer 3 is arranged with a side facing away from the surface on the base layer 7.

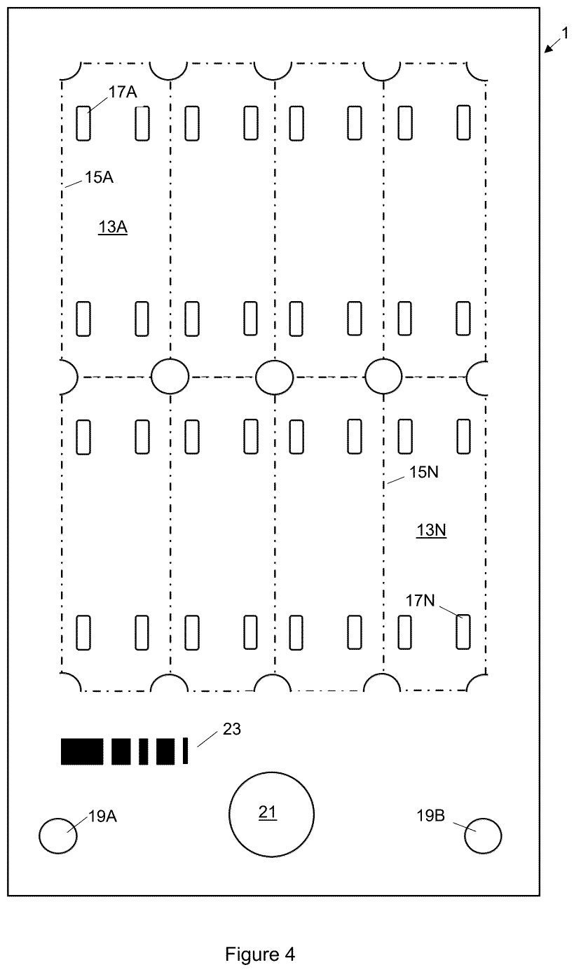

In the embodiment shown, the first polymer material in the cover layer 3 comprises a G-PET material and the second material in the base layer 7 comprises an A-PET material. The G-PET material used has very good surface properties and is therefore very suitable for marking using a printing device, such as a thermal transfer printer, laser printer and/or inkjet printer. The A-PET material shown contains up to 100% recycled material and is therefore less high grade and of lower quality than the G-PET material, but is therefore cheaper to produce and can provide good mechanical rigidity and tensile strength for marking and for arranging the labeling element 1 and/or the labeling elements obtained from the labeling material 1, as shown below in FIG. 4, on the element being identified. The mechanical properties of the labeling material 1 can advantageously be determined via the thickness of the layers 3, 7.

In the embodiment shown, the cover layer 3 has a thickness D1 and the base layer 7 has a thickness D2, wherein the thickness D1 of the cover layer 3 is less than the thickness D2 of the base layer 5.

Furthermore, it is shown that the cover layer 3 and the base layer 7 are complementary to each other, congruently overlapping, and unprofiled. Only the layer thicknesses D1 and D2 are different in order to advantageously minimize the thickness D1 of the expensive cover layer 3, comprising the A-PET material. In the embodiment shown, the thickness D1 of the cover layer 3 is less than or equal to 50 μm.

Furthermore, FIG. 1 shows that an adhesive layer 5 is arranged between the cover layer 3 and the base layer 7 for connecting the cover layer 3 to the base layer 7. In the embodiment shown, the adhesive layer 5 is arranged as a thin adhesive film between the two layers 3, 7. In order to connect the two layers 3, 7, in further embodiments the two layers 3, 7 can also be pressed and/or heated in order to create a material bond.

FIG. 2 shows a sectional view through the labeling material 1 previously shown in FIG. 1 with an adhesive 9 arranged on the base layer 7. The adhesive 9 shown serves to arrange the labeling material 1, or the labeling elements obtained from the labeling material 1, as shown below in FIG. 4, on an element being identified.

In the embodiment shown, the adhesive 9 is realized by a double-sided adhesive tape which is arranged on a side of the labeling material 1 opposite the printable surface. The labeling material 1, or the labeling elements obtained from the labeling material 1, as shown below in FIG. 4, can also be arranged in a form-fitting and/or force-fitting manner on the element being identified.

FIG. 3 shows a sectional view through a labeling material 1 comprising a three-layer polymer film according to one embodiment. In the embodiment shown, the labeling material 1 comprises two printable cover layers 3, 11, each comprising a G-PET material.

The cover layers 3, 11 are each arranged on opposite sides of a base layer 7 comprising an A-PET material. The labeling material 1 shown in FIG. 3 can be printed on both sides, i.e. in contrast to the embodiments of the labeling material shown in FIGS. 1 and 2.

FIG. 4 shows a plan view of the surface of the cover layer of a labeling material 1 according to one embodiment. The labeling material 1 may, for example, be one of the labeling materials previously shown in one of FIG. 1-3.

The unprinted labeling material 1 shown can be printed in one step using a thermal transfer, laser and/or inkjet printing device.

In the embodiment shown, eight labeling elements 13A-13N are shown, which can be removed from the labeling material 1 shown after marking. In further embodiments, however, more or fewer than eight labeling elements 13A-13N can be arranged in the labeling material 1 or removed from the labeling material 1. For example, in an embodiment, the labeling material 1 can also be used as a single labeling element.

Furthermore, FIG. 4 shows a plurality of material weakenings 15A, 15N which form a perforation. The perforation enables the labeling material 1 to be separated into the labeling elements 13A-13N shown. The material weakenings 15A-15N shown can be introduced into the labeling material 1 as punched perforations. Alternatively, the material weakenings 15A-15N can also be introduced into the labeling material 1 using a laser. The remaining material of the labeling material 1, which is arranged in a frame-like manner around the labeling elements 13A-13N, serves as support material for the labeling elements 13A-13N.

In the embodiment shown in FIG. 4, the labeling elements 13A-13N all have the same dimensions. Depending on the intended application, the labeling elements 13A-13N may also have different dimensions.

It is also shown in the embodiment of FIG. 4 that further material weakenings 17A-17N are introduced into the labeling material 1 in the areas of the labeling elements 13A-13N, for fastening the labeling elements 13A-13N to the respective elements to be identified.

For example, a cable tie can be passed through the further material weakenings 17A-17N to easily attach the labeling elements 13A-13N to the elements to be identified.

Furthermore, two positioning openings 19A, 19B are introduced into the labeling material 1 of the embodiment shown in FIG. 4, by way of example, for inserting and positioning multiple sheets of similar labeling material 1 in a supply magazine of the printing device (not shown in FIG. 4). For easy insertion and removal of the labeling material 1 from the storage magazine, a handling recess 21 is arranged in the embodiment shown in FIG. 4, through which the user can, for example, insert a finger.

Also, a code 23, which is shown as a barcode, is printed on the labeling material 1 of the embodiment shown in FIG. 4, by way of example. By means of a suitable reading means on the printing device, the code 23 can be read and the read-out information can be used in the printing device to adapt the print image according to the labeling material or the dimensions and arrangements of the labeling elements 13A-13N in the labeling material 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Labeling material
3 Cover layer
5 Adhesive layer
7 Base layer
9 Adhesive
11 Additional cover layer
13A-13N Labeling elements
15A-15N Material weakenings
17A-17N Further material weakenings
19A, 19B Position openings
21 Handling recess
23 Code
D1 Layer thickness of the cover layer
D2 Layer thickness of the base layer

1. A labeling material for identifying elements, the labeling material comprising:
a cover layer comprising a first polymer material and having a surface configured to be marked with a printing device; and
a base layer comprising second polymer material,
wherein the cover layer is arranged via a side facing away from a surface on the base layer, and
wherein
the first polymer material comprises a polymer material of a higher quality than the second polymer material.

2. The labeling material of claim 1, wherein the first polymer material comprises a G-PET polyethylene terephthalate material and the second polymer material comprises an A-PET polyethylene terephthalate material.

3. The labeling material of claim 1, wherein the cover layer has a thickness and the base layer has a thickness and
wherein the thickness of the cover layer is less than the thickness of the base layer.

4. The labeling material of claim 3, wherein the thickness of the cover layer is in a range of two to ten times less than the thickness of the base layer.

5. The labeling material of claim 1, wherein the thickness of the cover layer is less than or equal to 50 μm.

6. The labeling material of claim 1, wherein the cover layer or the base layer is colored and an other of the cover layer or the base layer is transparent.

7. The labeling material of claim 1, wherein an adhesive layer is arranged at least in places between the cover layer and the base layer so as to connect the cover layer to the base layer.

8. The labeling material of claim 1, wherein the surface of the cover layer is markable by at least one of a thermal transfer, laser, and inkjet printing device.

9. The labeling material of claim 1, further comprising:
an adhesive arranged at least in places on a region of the base layer so as to arrange the labeling material on the element being identified.

10. The labeling material of claim 1, wherein the labeling material is flat or strip-shaped.

11. The labeling material of claim 1, wherein at least one material weakening is introduced into the cover layer and/or base layer so as to separate the labeling material into at least two labeling elements.

12. The labeling material of claim 11, wherein at least one further material weakening is introduced into the cover layer and/or base layer of at least one separated labeling element of the separated labeling elements so as to fasten the separated labeling element to the element being identified.

13. The labeling material of claim 1, further comprising:
a further cover layer.

14. The labeling material of claim 1, wherein the further cover layer comprises a further first polymer material with a higher quality than the second polymer material of the base layer.

15. The labeling material of claim 4, wherein the thickness of the cover layer is five times less than the thickness of the base layer.

16. The labeling material of claim 5, wherein the thickness of the cover layer is less than or equal to 10 μm.

17. The labeling material of claim 6, wherein the cover layer is colored and the base layer is transparent.

18. The labeling material of claim 9, wherein the adhesive comprises a material bond.

19. The labeling material of claim 11, wherein the at least one material weakening comprises a perforation.

20. The labeling material of claim 13, wherein the further cover layer is arranged opposite the cover layer on the base layer.
